(19) United States
(12) Patent Application Publication
(10) Pub. No.: US 2020/0265377 A1
(43) Pub. Date: Aug. 20, 2020

(54) TRACKING SYSTEM AND METHOD

(71) Applicant: ABU DHABI PORTS COMPANY PJSC, Abu Dhabi (AE)

(72) Inventors: Noura Ahmed Sultan Saeed AL DHAHERI, Abu Dhabi (AE); Vincent Gonzalez URBINA, Abu Dhabi (AE)

(21) Appl. No.: 16/651,524

(22) PCT Filed: Sep. 27, 2018
(86) PCT No.: PCT/AU2018/051056

§ 371 Date: Mar. 27, 2020

(30) Foreign Application Priority Data
Sep. 27, 2017 (GB) 1715641.5
Feb. 6, 2018 (AU) PCT/AU2018/050082

(51) Int. Cl. G06Q 10/08; G06N 20/00

(52) U.S. Cl. CPC G06Q 10/0831; G06N 20/00; G06Q 10/0838

(57) ABSTRACT

A tracking system comprising: a central control arrangement (1) which is configured to communicate with a client device (11), the central control arrangement (1) comprising: a processor; and a memory coupled for communication with the processor, wherein the central control arrangement (1) is configured to: receive vessel data from a plurality of vessel data sources (6-8) and store the vessel data in the memory, the vessel data indicating at least one vessel status parameter for a vessel (2, 3); receive cargo data from at least one cargo data source (6-8) and store the cargo data in the memory, the cargo data comprising at least an item identifier which identifies an item of cargo carried by the vessel (2, 3); receive port data from at least one port data source (12-15) and store the port data in the memory, the port data comprising at least one port parameter related to the vessel (2, 3); receive a tracking request from the client device (11) which requests tracking data corresponding to one or more of the vessel or the cargo; and in response to the tracking request, output at least a portion of the tracking data to the client device (11) to enable a user of the client device (11) to track at least one of the vessel or the cargo.

The present invention relates to a tracking system and method. The present invention more particularly relates to a tracking system and method for tracking vessels and cargo.

The maritime industry is complex and competitive and there is a need for accurate and real-time information regarding the location and status of vessels and cargo both on a local scale and a global scale. The information includes, for instance, the status of vessels and the goods being shipped. It is vital for shipping agents and others within the maritime industry to receive current and accurate tracking information regarding vessels and cargo. It is important to track the time of arrival, time berthed, time of departure, approval, holds and even rejections from different entities for vessels and cargo since each of these will affect the next port schedule for the vessels and cargo. Tracking information that is not accurate or not current can lead to delays at ports and on shipping lines which can significantly reduce the speed and efficiency of the ports and shipping lines.

There is a need for an improved tracking system and method which alleviates at least some of the problems described above.

The present invention seeks to provide an improved tracking system and method.

According to one aspect of the present invention, there is provided a tracking system comprising: a central control arrangement which is configured to communicate with a client device, the central control arrangement comprising: a processor; and a memory coupled for communication with the processor, wherein the central control arrangement is configured to: receive vessel data from a plurality of vessel data sources and store the vessel data in the memory, the vessel data indicating at least one vessel status parameter for a vessel; receive cargo data from at least one cargo data source and store the cargo data in the memory, the cargo data comprising at least an item identifier which identifies an item of cargo carried by the vessel; receive port data from at least one port data source and store the port data in the memory, the port data comprising at least one port parameter related to the vessel; receive a tracking request from the client device which requests tracking data corresponding to one or more of the vessel or the cargo; and in response to the tracking request, output at least a portion of the tracking data to the client device to enable a user of the client device to track at least one of the vessel or the cargo.

Preferably, the client device is a mobile device selected from a group including a smartphone, a tablet, a smartwatch or a portable computer.

Conveniently, the system further comprises: at least one beacon arrangement which is configured to communicate with the central control arrangement and the client device, wherein the at least one beacon arrangement is configured to communicate with the client device over a limited distance range.

In some embodiments, the at least one beacon arrangement is configured to communicate directly with the client device over a limited distance range of up to 500 metres.

In some embodiments, the at least one beacon arrangement is configured to communicate directly with the client device over a limited distance range of up to 100 metres.

Preferably, the at least one beacon arrangement is configured to communicate with the client device using a communication protocol selected from a group including Bluetooth™, WiFi™, Zigbee™, Z-Wave™, 6LowPAN™, Sigfox™ or LoRaWAN™.

Conveniently, the client device is configured to restrict a user from accessing at least one function of the client device when the client device is not within the limited distance range of at least one beacon arrangement.

Advantageously, the central control arrangement is configured to calculate the geographic position of the client device relative to the known geographic position of the at least one beacon arrangement based on data communication between the client device and the at least one beacon arrangement.

Preferably, the client device is configured to: send a tracking request to the central control arrangement, the tracking request requesting tracking data corresponding to one or more of a vessel or an item of cargo; receive tracking data corresponding to at least one of: vessel data from a plurality of vessel data sources which indicates at least one vessel status parameter for a vessel, or cargo data from at least one cargo data source which comprises at least an item identifier which identifies an item of cargo carried by the vessel; and output at least a portion of the tracking data to a user interface of the client device.

Conveniently, the at least one vessel status parameter comprises one or more of: the location of the vessel, an approval for the vessel, the expected time of arrival of the vessel at a location, the expected time of berthing of the vessel, the expected time of departure of the vessel from a location, the actual time of arrival of the vessel at a location, the actual time of departure of the vessel from a location, an International Maritime Organization (IMO) number, or the last ten ports visited by the vessel.

Advantageously, the cargo data further comprises one or more of: a physical status of the item of cargo; a physical condition of the item of cargo; a business condition of the item of cargo; or an event associated with the item of cargo.

Preferably, the physical and/or business status of the item of cargo comprises a status selected from a group including loaded, unloaded, trade import, trade export, gated in, gated out, verified gross mass (VGM) weight, verified gross mass (VGM) status, delivery order status, release status, appointment status, payment status, free days status or customs clearance status.

Conveniently, the port data comprises one or more port parameters selected from a group including: a port name, the estimated number of voyages to a port and within a time frame, the number of the voyages arrived at a port, the number of voyages departed from a port, voyages calendar data representing the count of expected, arrived and departed voyages on a particular date for at least one port, the estimated number of voyages to a terminal within a time frame, the number of the voyages arrived at a terminal, the number of voyages departed from a terminal, voyages calendar data representing the count of expected, arrived and departed voyages on a particular date for at least one terminal in a port.

Advantageously, the plurality of vessel data sources are selected from a group including a port authority system, a marine service provider system, a customs authority system, a port operator system, a shipping line system, a shipping agent system or a system accessible via the Internet.

Preferably, the tracking request comprises a cargo identifier which identifies an item of cargo.

Conveniently, the tracking request comprises a vessel identifier which identifies a vessel.

Advantageously, the tracking request requests tracking data comprising the status of tracking documents across a plurality of different entities.

Preferably, the tracking documents are selected from a group including a manifest status, a loading list or a discharge list.

Conveniently, the client device is configured to: provide an alert message to a user comprising at least a portion of the tracking data.

Preferably, the client device is configured to provide the alert message to the user in the form of a push notification.

Conveniently, the client device is configured to: group a portion of the vessel data and a portion of the cargo data for a user; and output to the user at least a portion of the tracking data corresponding to the grouped vessel data and cargo data.

Advantageously, the central control arrangement is configured to: transmit a port clearance document to the client device to enable a user to process a port clearance document related to the user's vessel using the client device.

Preferably, the memory of the central control arrangement is a data storage repository within a server or a plurality of network connected servers.

Conveniently, the central control arrangement is configured to: store statistics data corresponding to the vessel data and/or the cargo data over period of time.

Advantageously, the central control arrangement further comprises: a machine learning module which is configured to use machine learning to analyse historical data and current data generated by the system to generate at least one of a predicted arrival time and a predicted departure time for a vessel.

According to another aspect of the present invention, there is provided a tracking method comprising: receiving vessel data from a plurality of vessel data sources, the vessel data indicating at least one vessel status parameter for a vessel; receiving cargo data from at least one cargo data source, the cargo data comprising at least an item identifier which identifies an item of cargo carried by the vessel; receiving port data from at least one port data source and store the port data in the memory, the port data comprising at least one port parameter related to the vessel; storing the vessel data, cargo data and the port data in a memory of a central control arrangement of a tracking system; receiving a tracking request which requests tracking data corresponding to one or more of the vessel or the cargo; and in response to the tracking request, outputting at least a portion of the tracking data to a user to enable the user to track at least one of the vessel or the cargo.

Preferably, the method further comprises: communicating data between the client device and at least one beacon arrangement directly over a limited distance range.

In some embodiments, the limited distance range is a distance of up to 500 metres.

In some embodiments, the limited distance range is a distance of up to 100 metres.

Preferably, the method comprises communicating between the at least one beacon arrangement and the client device using a communication protocol selected from a group including Bluetooth™, WiFi™, Zigbee™, Z-Wave™, 6LowPAN™, Sigfox™ or LoRaWAN™.

Conveniently, the method further comprises: restricting a user from accessing at least one function of the client device when the client device is not within the limited distance range of at least one beacon arrangement.

Advantageously, the method further comprises: calculating the geographic position of the client device relative to the known geographic position of the at least one beacon arrangement based on data communication between the client device and the at least one beacon arrangement.

Preferably, the at least one vessel status parameter comprises one or more of: the location of the vessel, an approval for the vessel, the expected time of arrival of the vessel at a location, the expected time of berthing of the vessel, the expected time of departure of the vessel from a location, the actual time of arrival of the vessel at a location, the actual time of departure of the vessel from a location, an International Maritime Organization (IMO) number, or the last ten ports visited by the vessel.

Conveniently, the cargo data further comprises one or more of: a physical status of the item of cargo; a physical condition of the item of cargo; a business condition of the item of cargo; or an event associated with the item of cargo.

Advantageously, the physical and/or business status of the item of cargo comprises a status selected from a group including loaded, unloaded, trade import, trade export, gated in, gated out, verified gross mass (VGM) weight, verified gross mass (VGM) status, delivery order status, release status, appointment status, payment status, free days status or customs clearance status.

Preferably, the port data comprises one or more port parameters selected from a group including: a port name, the estimated number of voyages to a port and within a time frame, the number of the voyages arrived at a port, the number of voyages departed from a port, voyages calendar data representing the count of expected, arrived and departed voyages on a particular date for at least one port, the estimated number of voyages to a terminal within a time frame, the number of the voyages arrived at a terminal, the number of voyages departed from a terminal, voyages calendar data representing the count of expected, arrived and departed voyages on a particular date for at least one terminal in a port.

Conveniently, the plurality of vessel data sources are selected from a group including a port authority system, a marine service provider system, a customs authority system, a port operator system, a shipping line system, a shipping agent system or a system accessible via the Internet.

Advantageously, the tracking request comprises a cargo identifier which identifies an item of cargo.

Preferably, the tracking request comprises a vessel identifier which identifies a vessel.

Conveniently, the tracking request requests tracking data comprising the status of tracking documents across a plurality of different entities.

Advantageously, the tracking documents are selected from a group including a manifest status, a loading list or a discharge list.

Preferably, the method further comprises: providing an alert message to a user comprising at least a portion of the tracking data.

Conveniently, the method comprises providing the alert message to the user in the form of a push notification.

Advantageously, the method further comprises: grouping a portion of the vessel data and a portion of the cargo data for a user; and outputting to the user at least a portion of the tracking data corresponding to the grouped vessel data and cargo data.

Preferably, the method further comprises: transmitting a port clearance document from the central control arrangement to a mobile device to enable a user to process a port clearance document related to the user's vessel using the mobile device.

Conveniently, the method further comprises: storing statistics data corresponding to the vessel data and/or the cargo data over period of time.

Advantageously, the method further comprises: using machine learning to analyse historical data and current data generated by the system to generate at least one of a predicted arrival time and a predicted departure time for a vessel.

Preferably, method comprises outputting at least a portion of the tracking data to a mobile device.

Conveniently, the mobile device is a mobile device selected from a group including a smartphone, a tablet, a smartwatch or a portable computer.

According to another aspect of the present invention, there is provided a computer program having instructions which, when executed by a computing device or system cause the computing device or system to perform the method of any one of claims 26 to 49 as defined hereinafter.

According to another aspect of the present invention, there is provided a tangible computer readable medium storing instructions which, when executed by a processor, perform the method of any one of claims 26 to 49 as defined hereinafter.

According to another aspect of the present invention, there is provided a tracking method comprising: receiving vessel data from a plurality of vessel data sources, the vessel data indicating at least one vessel status parameter for a vessel; receiving cargo data from at least one cargo data source, the cargo data comprising at least an item identifier which identifies an item of cargo carried by the vessel; storing the vessel data and the cargo data in a memory of a tracking system; receiving a tracking request which requests tracking data corresponding to one or more of the vessel or the cargo; and in response to the tracking request, outputting at least a portion of the tracking data to a user to enable the user to track at least one of the vessel or the cargo.

According to another aspect of the present invention, there is provided a tracking method for use with a mobile device, the method comprising: sending a tracking request from a mobile device to a tracking system, the tracking request requesting tracking data corresponding to one or more of a vessel or an item of cargo; receiving, at the mobile device, tracking data corresponding to at least one of: vessel data from a plurality of vessel data sources which indicates at least one vessel status parameter for a vessel, or cargo data from at least one cargo data source which comprises at least an item identifier which identifies an item of cargo carried by the vessel; and outputting at least a portion of the tracking data to a user interface of the mobile device.

According to another aspect of the present invention, there is provided a tracking system comprising: a processor; and a memory coupled for communication with the processor, the memory storing vessel data from a plurality of vessel data sources, the vessel data indicating at least one vessel status parameter for a vessel, wherein the memory further stores cargo data from at least one cargo data source, the cargo data comprising at least an item identifier which identifies an item of cargo carried by the vessel, wherein the memory further stores instructions which, when executed by the processor, are configured to: receive a tracking request which requests tracking data corresponding to one or more of the vessel or the cargo; and in response to the tracking request, output at least a portion of the tracking data to a user to enable the user to track at least one of the vessel or the cargo.

So that the present invention may be more readily understood, embodiments of the present invention will now be described, by way of example, with reference to the accompanying drawings, in which:

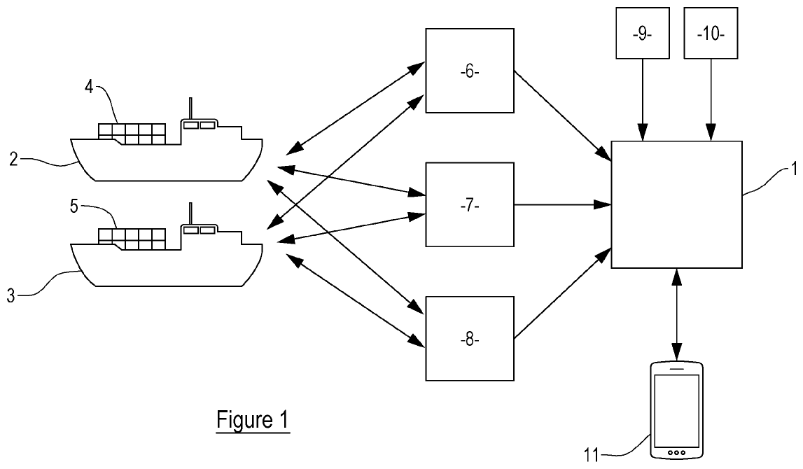

FIG. 1 is a schematic diagram of a tracking system of some embodiments,

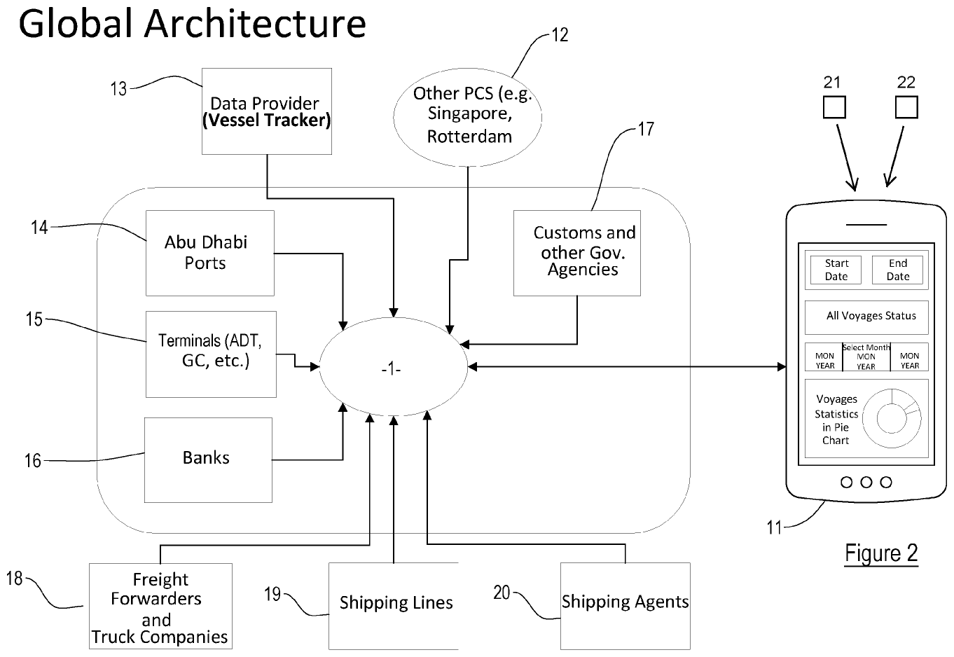

FIG. 2 is a schematic diagram of a tracking system of some embodiments,

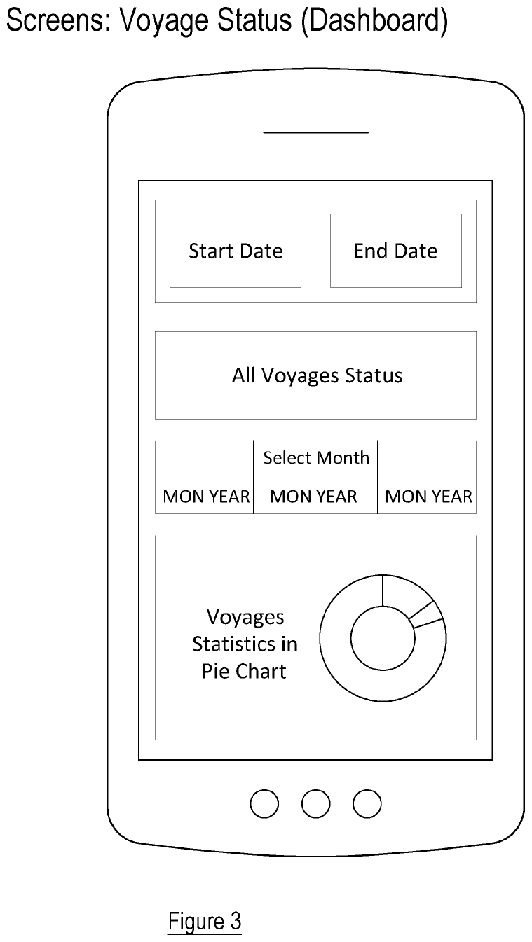

FIG. 3 is a schematic diagram of a mobile device for use with a tracking system of some embodiments, with a display screen of the mobile device displaying a dashboard interface,

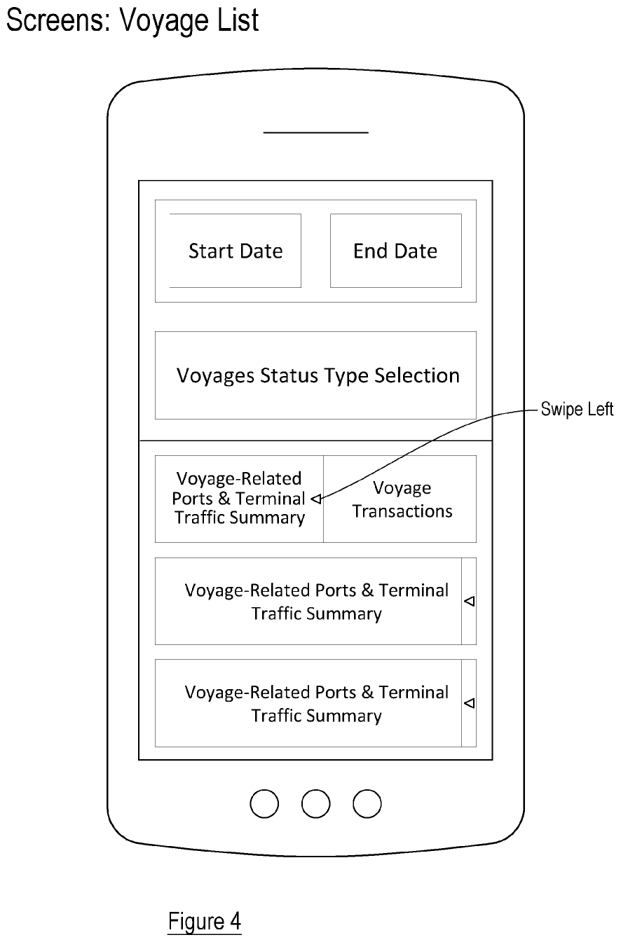

FIG. 4 is a schematic diagram of a mobile device for use with a tracking system of some embodiments, with a display screen of the mobile device displaying a voyage list,

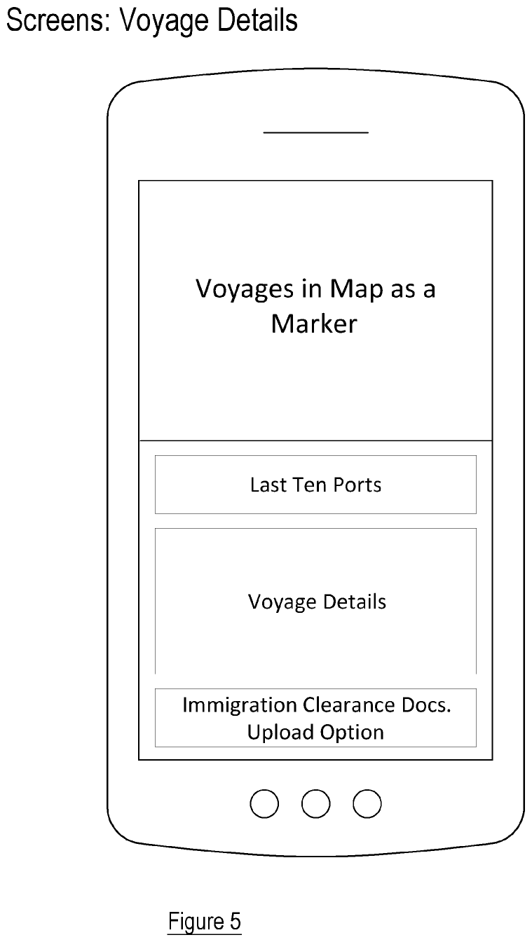

FIG. 5 is a schematic diagram of a mobile device for use with a tracking system of some embodiments, with a display screen of the mobile device displaying voyage details,

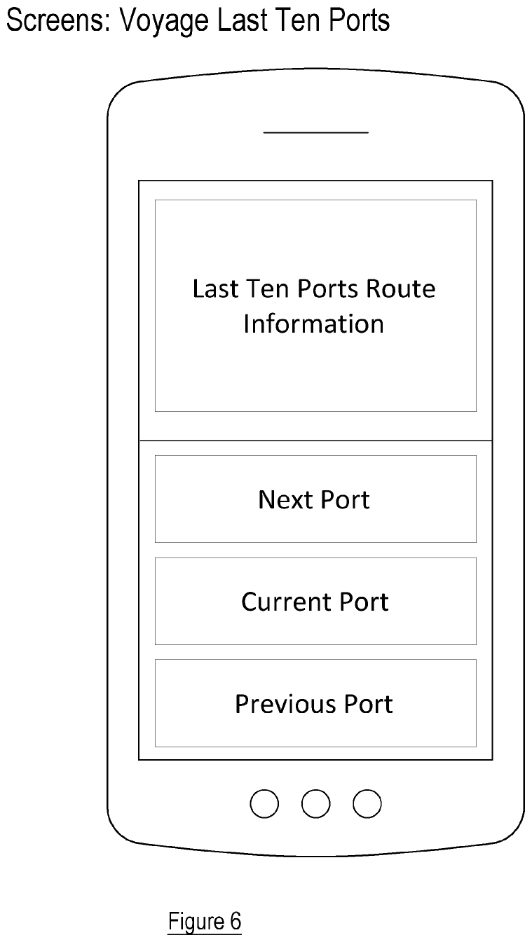

FIG. 6 is a schematic diagram of a mobile device for use with a tracking system of some embodiments, with a display screen of the mobile device displaying details of ports visited by a vessel,

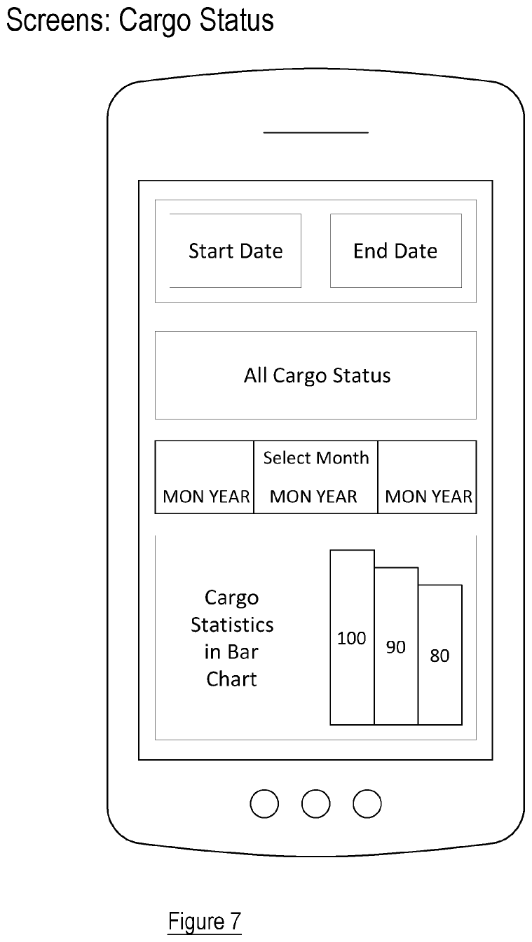

FIG. 7 is a schematic diagram of a mobile device for use with a tracking system of some embodiments, with a display screen of the mobile device displaying a cargo status,

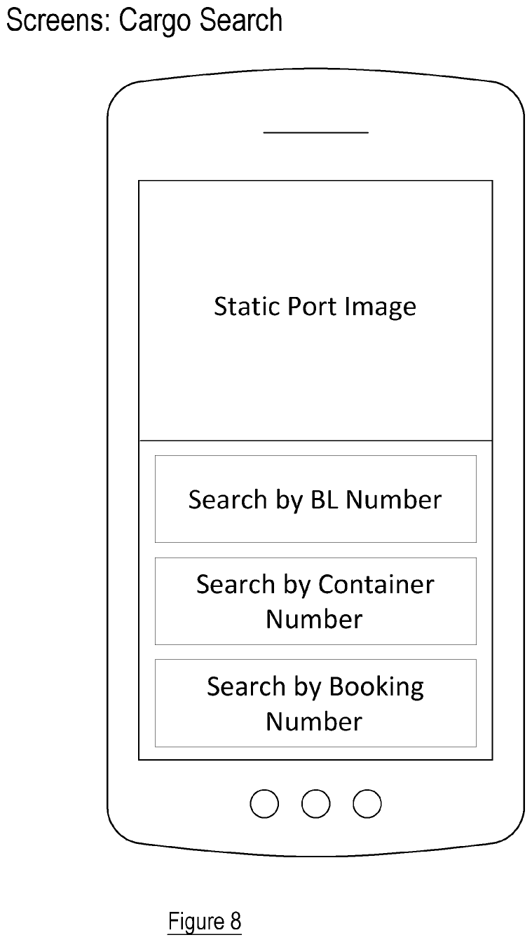

FIG. 8 is a schematic diagram of a mobile device for use with a tracking system of some embodiments, with a display screen of the mobile device displaying an interface for performing a cargo search,

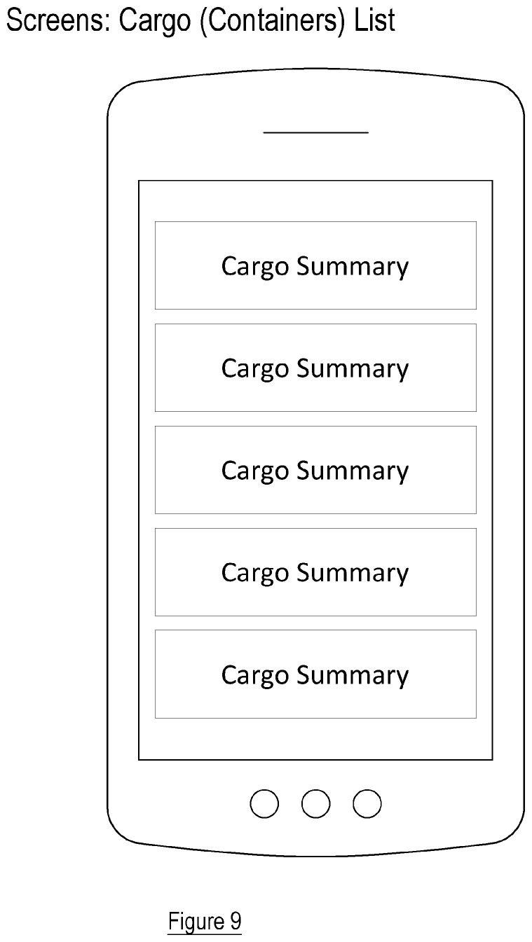

FIG. 9 is a schematic diagram of a mobile device for use with a tracking system of some embodiments, with a display screen of the mobile device displaying a list of cargo summaries,

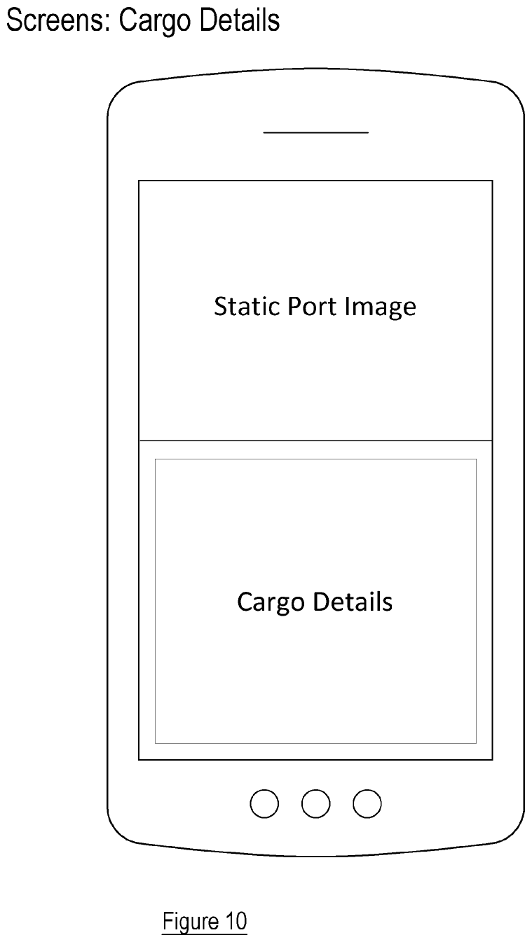

FIG. 10 is a schematic diagram of a mobile device for use with a tracking system of some embodiments, with a display screen of the mobile device displaying cargo information,

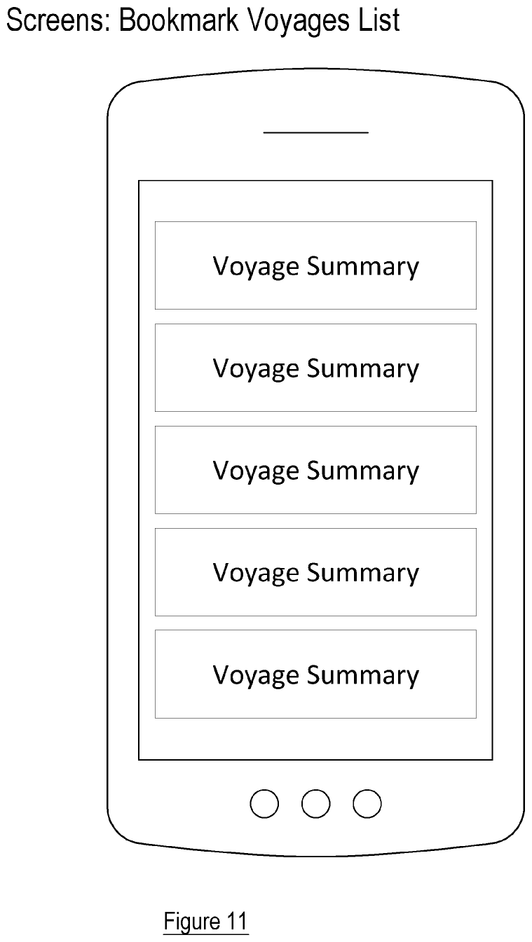

FIG. 11 is a schematic diagram of a mobile device for use with a tracking system of some embodiments, with a display screen of the mobile device displaying voyage summaries for bookmarked voyages,

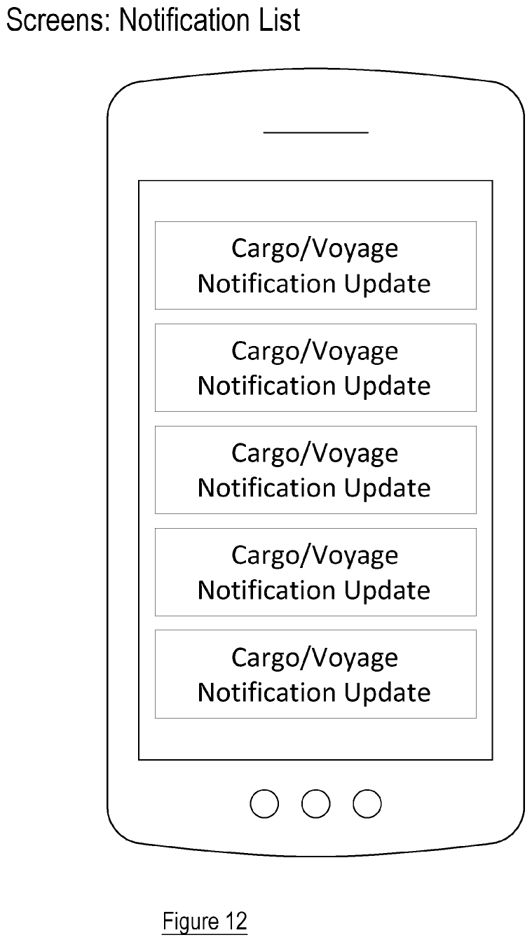

FIG. 12 is a schematic diagram of a mobile device for use with a tracking system of some embodiments, with a display screen of the mobile device displaying notification list, and

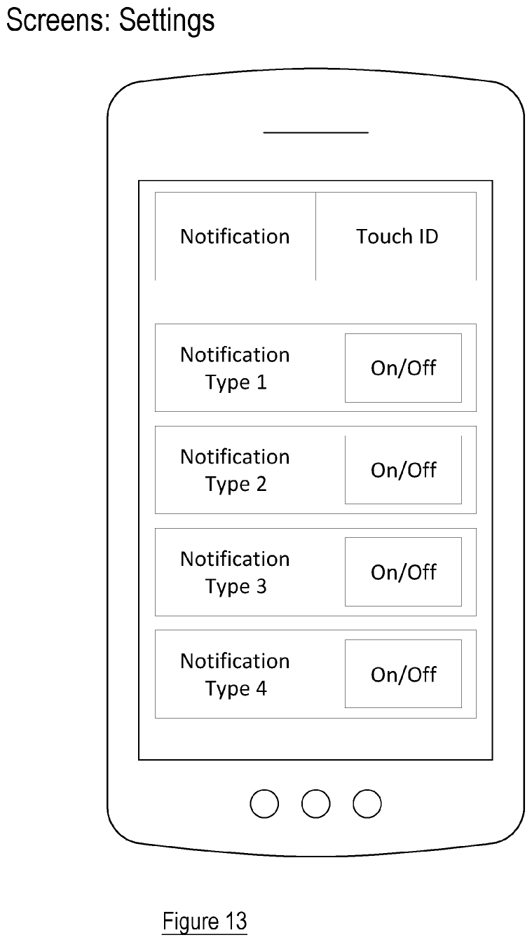

FIG. 13 is a schematic diagram of a mobile device for use with a tracking system of some embodiments, with a display screen of the mobile device displaying a settings dashboard.

Referring initially to FIG. 1 of the accompanying drawings, a tracking system 1 is configured for tracking the location and/or status of a plurality of vessels 2, 3 and cargo 4, 5 carried by each vessel 2, 3.

The vessels 2, 3 are any type of vessel that is capable of transporting cargo by sea or across other bodies of water, such as oceans, lakes, rivers or canals.

The cargo 4, 5 is any type of cargo which may or may not be packed within a container. In some embodiments, each item of cargo 4, 5 is a container which contains a plurality of items that are being shipped. For simplicity, the following description will refer to the cargo 4, 5 as items of cargo.

Each vessel 2, 3 comprises equipment which is configured to transmit vessel data and cargo data to at least one shipping entity. In FIG. 1, each vessel 2, 3 is configured to transmit cargo data and/or vessel data to three shipping entities 6-8. However, it is to be appreciated that in some embodiments, each vessel 2, 3 is configured to transmit vessel data and/or cargo data to a greater or fewer number of shipping entities than the three shown in FIG. 1. The arrows extending between the vessels 2, 3 and each of the shipping entities 6-8 indicate data communication between the vessels 2, 3 and the shipping entities 6-8. The data communication between the vessels 2, 3 and the shipping entities 6-8 may be one-way or two-way.

The data is communicated between the vessels 2, 3 and the shipping entities 6-8 by a communication means, such as satellite or radio communication. The data is typically communicated at least partly via the Internet.

Each vessel 2, 3 is provided with equipment to record data which is indicative of the status of the vessel and the cargo carried by the vessel. In some embodiments, each vessel 2, 3 carries satellite navigation system, such as a global positioning system (GPS) receiver, which is configured to record the geographic location of the vessel. The position data from the satellite navigation system forms part of the vessel data that is transmitted from the vessel to at least one of the shipping entities so that the at least one shipping entity can track the location of the vessel.

In some embodiments, each vessel 2, 3 is provided with equipment to record the physical status of cargo being carried by the vessel. In some embodiments, this equipment records physical condition parameters of cargo, such as temperature or humidity and whether or not the cargo is damaged.

Each of the shipping entities 6-8 is configured to transmit vessel data and/or cargo data to the tracking system 1. The data is typically transmitted via the Internet.

In some embodiments, the tracking system 1 is configured to receive additional shipping data from one or more additional data sources 9, 10. These additional shipping data sources are described in more detail below.

The tracking system 1 is configured to communicate with a client device 11 which, in this embodiment, is a mobile device. In some embodiments, the mobile device is selected from a group including a smartphone, a tablet, a smartwatch or a portable computer, such as a laptop.

Referring now to FIG. 2 of the accompanying drawings, the tracking system 1 of some embodiments comprises a central control arrangement which is configured to receive shipping data from a plurality of additional data sources which are selected from a group including, but not limited to, at least one Port Community System (PCS) 12, a data provider or vessel tracker 13, a predetermined PCS (e.g. Abu Dhabi Ports) 14, a shipping data terminal 15, a bank 16, customs and/or other government agencies 17, freight forwarders and/or truck companies 18, shipping lines 19 or shipping agents 20.

The tracking system 1 and its central control arrangement of some embodiments is implemented in computer hardware or data processing apparatus, such as a server. The tracking system 1 comprises a plurality of modules which are implemented in the technical hardware to perform tasks within the system.

The central control arrangement of the tracking system 1 comprises at least a processor and a memory coupled for communication with the processor. The memory stores vessel data from a plurality of vessel data sources, the vessel data indicating at least one vessel status parameter for a vessel. The memory further stores cargo data from at least one cargo data source, the cargo data comprising at least one item identifier which identifies an item of cargo carried by the vessel. The memory further stores port data from at least one port data source, the port data comprising at least one port parameter related to the vessel. The memory further stores instructions which, when executed by the processor, are configured to receive a tracking request which requests tracking data corresponding to one or more of the vessel 2, 3 or the cargo 4, 5 and, in response to the tracking request, to output at least a portion of the tracking data to a user to enable the user to track at least one of the vessel 2, 3 or the cargo 4, 5.

In some embodiments, the memory of the tracking system 1 is a data storage repository comprising a server or a plurality of network connected servers.

A tracking method is performed using the tracking system 1 by receiving vessel data at the tracking system 1 from a plurality of vessel data sources, such as the shipping entities 6-8 or the additional data sources described above. The vessel data indicates at least one vessel status parameter for a vessel 2, 3. The at least one vessel status parameter comprises one or more of the location of the vessel, an approval for the vessel, the expected time of arrival of the vessel at a location, the expected time of berthing of the vessel, the expected time of departure of the vessel from a location, the actual time of arrival of the vessel at a location, the actual time of departure of the vessel from a location, an International Maritime Organization (IMO) number or the last ten ports visited by the vessel.

The method further comprises receiving port data from at least one port data source and storing the port data, the port data comprising at least one port parameter related to the vessel.

In some embodiments, the port data comprises one or more port parameters selected from a group including, but not limited to: a port name, the estimated number of voyages to a port and within a time frame, the number of the voyages arrived at a port, the number of voyages departed from a port, voyages calendar data representing the count of expected, arrived and departed voyages on a particular date for at least one port, the estimated number of voyages to a terminal within a time frame, the number of the voyages arrived at a terminal, the number of voyages departed from a terminal, voyages calendar data representing the count of expected, arrived and departed voyages on a particular date for at least one terminal in a port.

The tracking system 1 is configured to start a vessel and/or cargo tracking operation in response to a tracking request sent from a client device 11, such as a mobile device, to the tracking system 1. The tracking request requests tracking data corresponding to one or more of a vessel 2, 3 or an item of cargo 4,5.

The tracking system 1 receives cargo data from at least one cargo data source, such as the shipping entities 6-8 or the additional data sources 9, 10. The cargo data comprises at least an item identifier which identifies an item of cargo 4, 5 carried by a vessel 2, 3. In some embodiments, the cargo data further comprises one or more of a physical status of the item of cargo, a physical condition of the item of cargo, a business condition of the item of cargo or an event associated with the item of cargo.

In some embodiments, the physical and/or business status of the item of cargo comprises a status selected from a group including loaded, unloaded, trade import, trade export, gated in, gated out, verified gross mass (VGM) weight, verified gross mass (VGM) status, delivery order status, release status, appointment status, payment status, free days status or customs clearance status.

In some embodiments, the tracking request comprises a cargo identifier which identifies an item cargo. In some embodiments, the cargo identifier is a series of reference numbers or letters which provide a coded identifier for an item of cargo.

In some embodiments, the tracking request comprises a vessel identifier which identifies a vessel. In some embodiments, the vessel identifier is a unique identifier which identifies a vessel from other vessels.

In some embodiments, the tracking request requests tracking data comprising the status of tracking documents across a plurality of different entities, such as the shipping entities 6-8. The tracking documents are selected from a group including, but not limited to, a manifest status, a loading list or a discharge list.

When the tracking system 1 receives the tracking request from the client device 11, the tracking system 1 matches the data requested in the tracking request with vessel data and/or cargo data stored in the memory of the tracking system 1. If the tracking system 1 identifies a match, the tracking system 1 outputs at least a portion of the tracking data stored in the memory of the tracking system 1 to a user to enable the user to track at least one of the vessel or the cargo.

For example, a user might be interested in tracking the location of a vessel and a physical status of an item of cargo on that vessel. The user is able to obtain this information easily by inputting the request to the client device 11. The client device 11 generates a tracking request based on the user input and transmits the tracking request to the tracking system 1 which, in turn, returns the relevant data indicating the location of the vessel and the physical status of the item of cargo carried by the vessel.

In some embodiments, the tracking system 1 is configured to provide an alert message to a user which comprises at least a portion of the tracking data. The tracking system 1 can therefore be configured to provide updates to a user via the client device 11 by providing alert messages that are tailored to the tracking data required by the user.

In some embodiments, the system is configured to provide an alert message to a user 48 hours before the arrival of a vessel if the vessel is not yet approved by customs or a terminal of a port.

In the case of Voyage Registration, in some embodiments the system is configured to provide an alert message to a user 24 hours before the arrival of a vessel if the call request is not yet approved.

In the case of Vessel Call Request, in some embodiments the system is configured to provide an alert message to a user 12 hours before the arrival of a vessel if the discharge list not yet approved.

In the case of Vessel Discharge List/Load List, in some embodiments the system is configured to provide an alert message to a user to alert the user to the number of bookings in rejection status in the last 24 hours and/or the number of delivery orders in rejection status in the last 24 hours.

In some embodiments, the tracking system 1 provides the alert message to the user in the form of a push notification to the client device 11. In some embodiments, the system is configured to provide a vessel Arrival notification to a user for a bookmarked vessel and/or a vessel Departure notification to a user for a bookmarked vessel.

In some embodiments, the tracking system 1 is configured to group a portion of the vessel data and a portion of the cargo data for a particular user. The tracking system 1 outputs at least a portion of the tracking data corresponding to the grouped vessel data and cargo data to the user such that a user can track a group of vessels and/or a group of items of cargo.

In some embodiments, the tracking system 1 is configured to input a port clearance document to the client device 11 to enable a user to process the port clearance document related to the user's vessel using the client device 11.

In some embodiments, the client device 11 is configured to use optical character recognition (OCR) so that a user may use a camera in the client device to take an image of a document and convert the image it into text. This functionality speeds up the process of data extraction from documents.

In some embodiments, the tracking system 1 is configured to store statistics data corresponding to the vessel data and/or the cargo data over a period of time. The tracking system 1 can therefore build up an historical record of statistical data regarding vessels and cargo.

Referring now to FIGS. 3-13 of the accompanying drawings, an application comprising computer readable code which executes on the client device 11 is configured to provide a user interface to a user. The client device 11 is preferably configured to receive a touch input from a user so that a user can interact with the user interface. As illustrated in FIGS. 3-13, the user interface displayed on the client device 11 is configured to output different information to a user regarding the status of a vessel and/or cargo.

The tracking system 1 of some embodiments addresses the need for transparency in operations in an unprecedented way, pulling information from Port Authority systems, Marine Service provider systems, Customs Authority systems, Port Operator systems, a shipping line system, a shipping agent system and the Internet in order to provide a digital lighthouse in the palm of the shipping agent. This allows users to be instantly and fully informed about the actions happening in the real world regarding their vessels and cargo.

In some embodiments, the tracking system 1 is configured to track a vessel's voyage and cargo, with the vessel data and voyage information in addition to the actual transactions status. A user can know his vessel call request status with Port Terminal Operator, Customs and Port Authorities. A user can also know the status of important documents across multiple entities; these documents include manifest status, loading list, and discharge list. A user can also process the port clearance documents directly from their mobile device. A user can also find his container information using the B/L number, container number or booking number in addition to the actual physical status and/or business status or condition of the container or other item of cargo (loaded, unloaded, gated in, gated out, verified gross mass (VGM) status, delivery order status, release status, appointment status, payment status, free days status or customs clearance status, etc.). The tracking system 1 also provides alerts, notifications, and bookmarks to enable a user to keep track of selective information.

In order for a maritime trade user to obtain the necessary information for a complete status update of the vessels and goods, currently they need to connect to different sources. This will consume both time and money because of the different subscriptions and platforms they have to access to obtain this information. The status of the vessel includes its location, different approvals from different entities, expected and actual times of arrival, berthing or departure. Cargo status also includes its physical condition and events. By contrast, the tracking system 1 merges the vessel data with the cargo data and provides a central solution for a user to access this data. In some embodiments, the merging is taken one step further by grouping the necessary information for each user on their own and provide it instantly to them as they log in instead of having to go through the process of manually correlating this information.

Currently, to obtain information about the location of the vessels, users have to independently subscribe to at least one of the available services online. Also, services that provide cargo tracking require their own independent subscription as well. Correlation of this data has to be done manually by the users. By contrast, the tracking system 1 of some embodiments merges some or all of these services and more into a single application available to users anywhere in the palm of their hand. In some embodiments, information about the transaction status with government and private entities concerned can be accessed only through manual or individual systems separated over the different entities working in isolation and providing partial information.

In some embodiments, the client device 11 is configured to execute a tracking application which may be downloaded and stored on the client device. A user must provide login details to access the information in the application. Once the user has logged in, the user is able to choose whichever service he needs by interacting with the user interface presented on the display screen of the client device. For instance, a user can provide a touch input to a touchscreen on the client device 11 to select a service in the menu and indicate a date range in order to be provided with the relevant information.

In some embodiments, the client device 11 is configured to provide a user, such as a shipping agent, with an option to update the estimated time of arrival (ETA) and the estimated time of departure (ETD) of a voyage stored by the system. This enables the user to send real time voyage information to the system.

In some embodiments, the client device 11 is configured to provide a user with an option to change the delivery order (DO) expiry date for an item of cargo. This enables the user to extend the DO expiry date easily via a client device.

In some embodiments, the system further comprises at least one beacon arrangement 21, 22 which is configured to be installed in a predetermined geographic position, such as a location at or in the vicinity of a port or in another location which is of interest to a shipping agent. In the embodiment shown in FIG. 2 there are two beacon arrangements 21, 22. However, in other embodiments the system comprises a greater or fewer number of beacon arrangements than the two shown in FIG. 2.

Each beacon arrangement 21, 22 is preferably configured to communicate with the central control arrangement of the tracking system 1, for instance via a network such as the Internet. Each beacon arrangement is also configured to transmit data to the client device 11 over a limited distance range.

In some embodiments, the at least one beacon arrangement is configured to transmit data directly to the client device 11 over a limited distance range of up to 500 metres or up to 100 metres.

Each beacon arrangement comprises a transmitter module which is configured to transmit data wirelessly to the client device 11. The transmitter module is preferably configured for one-way direct data transmission to the client device 11 so that the beacon arrangement can transmit coded data to the client device 11, when the client device 11 is within the limited distance range.

In some embodiments, the at least one beacon arrangement is configured to communicate with the client device using a communication protocol selected from a group including, but not limited to, Bluetooth™, WiFi™, Zigbee™, Z-Wave™, 6LowPAN™, Sigfox™ or LoRaWAN™. These communication protocols are typically two-way communication protocols but it is to be appreciated that, in some embodiments, the protocols are used for one-way data transmission from a beacon arrangement to a client device.

In some embodiments, the system 1 is configured to a track the location of a user via the user's client device 11 based on data received by the client device 11 from a beacon arrangement 21, 22. In these embodiments, the client device 11 communicates with the tracking system 1 to notify the tracking system 1 if the client device 11 is receiving data from one or more beacon arrangements, thereby notifying the tracking system 1 that the client device is within the limited distance range of one or more beacon arrangements.

In some embodiments, the system 1 is capable of tracking the location of a plurality of users via the users' client devices and to gather data about the movement of the users and by association the movement of vessels carrying the users. For instance, the system 1 is capable of tracking the number and preferably also the identity of users entering and exiting a port, port terminal or a particular area of interest. The position data gathered by the system 1 can also preferably be used by the system 1 identify high traffic areas within a port and any bottlenecks that might be occurring with vessels in a port or at another location of interest.

In some embodiments, the tracking functionality provided by the beacon arrangements enables the system to track a vessel which is identified by a Maritime Mobile Service Identity (MMSI) unique nine-digit identification number. In these embodiments, the system is configured to update a log with a vessel's MMSI once the vessel comes within range of at least one beacon arrangement, thereby indicating the arrival of the vessel. The system preferably also updates the log with the departure time of the vessel using the same principle.

In some embodiments, the system enables the location and direction of a vessel to be tracked while providing guidance to users and automatic updating of the estimated time of arrival of a vessel and/or its cargo. This is preferably carried out by the system entirely without the interaction of a user.

In some embodiments, the tracking functionality provided by the beacon arrangements enables the system to register and update the time and location to drop the shipment at the shipping company, for instance in accordance with a transport order. Additionally, the system ensures the time taken to pick and drop the shipment is within the allowed limits. This will enhances the precision and efficiency of a logistics system and tracking order while also ensuring its automation.

In some embodiments, the system is configured to use position data derived from data communication between the at least one beacon arrangement and a client device. This position data can be used in conjunction with GPS data to enhance positioning of the client device.

In some embodiments, the central control arrangement is configured to calculate the geographic position of the client device relative to the known geographic position of the at least one beacon arrangement based on data communication between the client device and the at least one beacon arrangement.

In some embodiments, the system comprises a machine learning module which is configured to use machine learning to predict the arrival and departure time of voyages and to generate predicted arrival time (PAT) and predicted departure time (PDT). In these embodiments, the system uses machine learning which takes into account historical data and newly generated data on a continuous basis to make accurate predictions. This significantly enhances the efficiency of operation of a terminal at a port by reducing the time-window required to block an assigned berth and for any hired equipment.

In some embodiments, the client device 11 is configured to display voyage/container lifecycle highlights. In these embodiments, the client device 11 is configured to display an events page which comprises a timeline (with a granularity of seconds) with information related to each event.

In some embodiments, the system is configured with a communication system to enable communication between customers, different stakeholders, other customers, and the customers' own team while sending and receiving documents directly through the mobile application running on client devices.

In some embodiments, the system is configured to allow training videos and documents to be uploaded to the client devices to enhance the user experience of the mobile application running on each client device.

In some embodiments, the system permits transporters to create new appointments or modify existing appointments, which will help users accommodate last minute changes in their business.

In some embodiments, the system is configured to provide a registration option to allow customers to register their companies directly with the mobile application running on the client device.

In some embodiments, the system is configured to allow a verified gross mass (VGM) certificate to be directly downloaded through the mobile application running on the client device.

In some embodiments, the system is configured to allow a service catalog of a port or another location to be viewed by the users through the mobile application running on the client device.

In some embodiments, the system is configured to provide an offline dashboard for users to store the customer's voyage data when a connection to the Internet is unavailable.

In some embodiments, the system is configured to provide widget shortcuts for the mobile application running on the client device. For example, the mobile application can appear as a widget on a Today Screen of the client device. A list of voyages with their status can also be listed for the user. By tapping on the widget, the mobile application is launched.

In some embodiments, the system is configured to enable a super user to create messages and broadcast them to some or all other profiles via the client devices. This is particularly useful when the platform users have to be notified about relevant events, such forecasted maintenances, new functionalities, service disruptions, etc.

In some embodiments, the system is configured to allow statistical data to be casted to the client device. In these embodiments, the client device is preferably configured to display a dashboard screen with pie charts for arrived, expected, and departed voyages.

In some embodiments, the mobile application running on the client device is configured to provide a print option or a share statistics option, for instance on the Cargo/Voyage chart view.

In some embodiments, a Freight Forwarder profile is provided as part of the mobile application running on a client device to allow a freight forward to plan operations, such as pre-arrival clearance, plan delivery of urgent import containers and adjust timing to bring export cargo to port, based on the information available within the system.

The user experience may be further enhanced by additional features in some embodiments. For instance, push notifications and bookmarking are two of the many features provided that allow the customers even faster access to the required data in a timely fashion and inform the user of updates as they happen.

In some embodiments, the client device 11 is configured for voice-control. For instance, in embodiments where the client device 11 is an iOS™ device such as an iPhone™ by Apple™ Inc., the client device is configured to enable the system to be voice-controlled by Siri™. In some embodiments, the client device is configured to use Siri Shortcuts™ for quick actions to control or receive information from the system via the client device 11. For example, a user may want to search for a voyage or check the status of current cargo so the user asks Siri™ to “Search Voyage” or “My Cargo” and Siri™ will navigate automatically to the specific requested screen to save user time. The client device is preferably configured to enable to perform this operation while the client device is displaying the lock screen mode or the notifications screen.

In some embodiments, the client device 11 is configured to output voice notifications to alert a user of the status of their voyage and/or cargo.

Users can view monthly voyage statistical data with enhanced analytics that will support in future decision making.

In existing shipping systems, service providers do not merge the data necessary for shipping/cargo agents. This means that these agents have to devote time and financial resources to obtain the required information from multiple. By contrast, the tracking system 1 of some embodiments provides merges data from multiple service providers and stores the merged data so that the tracking system 1 can provide a single source that provides all the information needed by users for a single subscription fee.

The tracking system 1 therefore brings together information from different sources to a single point of access. This is vital information for shipping agents who operate in an industry where time of arrival, berthing, departure, approval, holds and even rejections from different entities will affect their next port schedule and could have a negative financial impact on the ports operator as well as the shipping agents.

The tracking system 1 is able to track the voyage of a vessel, with the required vessel information and voyage information in addition to the actual transactions status. A user can know his vessel call request status with Port Terminal Operator, Customs and Port Authorities. A user can also know the status of important documents across multiple entities; these documents include manifest status, loading list, and discharge list. They can also process the port clearance documents directly from their phones. A user can also find his container information using the BL number, container number or booking number in addition to the actual physical status of the container (loaded, unloaded, gated in, gated out). It also has alerts, notifications, and bookmarks to keep track of selective information.

In the maritime industry, data collection is a crucial element that helps improve shipping services. Gathering this data is usually a challenge because it is disperse and costly. However, the tracking system 1 of some embodiments helps by gathering data from the trade by merging different sources that provide information about vessels and cargo. The tracking system 1 can use different techniques to extract useful information to provide better services, analyse real-time data and to forecast the evolution of the market.

This forward thinking tracking system in a relatively traditional industry revolutionises the processes involved by saving processing and operating time and reducing cost for all involved parties and increases the efficiency of vessel operations in ports.

In some embodiments, the tracking system 1 collects data all in one place and provides monthly statistics and analysis that helps in current and future decision-making. Data collection is one major issue that the tracking system takes care of and the tracking system also tackles data analysis in an efficient and low cost way.

Embodiments of the subject matter and the functional operations described herein can be implemented in digital electronic circuitry, or in computer software, firmware, or hardware, including the structures disclosed in this specification and their structural equivalents, or in combinations of one or more of them.

Some embodiments are implemented using one or more modules of computer program instructions encoded on a computer-readable medium for execution by, or to control the operation of, a data processing apparatus. The computer-readable medium can be a manufactured product, such as hard drive in a computer system or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks.

To provide for interaction with a user, some embodiments are implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A tracking system comprising:
a central control arrangement which is configured to communicate with a client device, the central control arrangement comprising:
a processor; and
a memory coupled for communication with the processor, wherein the central control arrangement is configured to:
receive vessel data from a plurality of vessel data sources and store the vessel data in the memory, the vessel data indicating at least one vessel status parameter for a vessel;
receive cargo data from at least one cargo data source and store the cargo data in the memory, the cargo data comprising at least an item identifier which identifies an item of cargo carried by the vessel;
receive port data from at least one port data source and store the port data in the memory, the port data comprising at least one port parameter related to the vessel;
receive a tracking request from the client device which requests tracking data corresponding to one or more of the vessel or the cargo; and
in response to the tracking request, output at least a portion of the tracking data to the client device to enable a user of the client device to track at least one of the vessel or the cargo.

2. The system of claim 1, wherein the client device is a mobile device selected from a group consisting of a smartphone, a tablet, a smartwatch or a portable computer.

3. The system of claim 1, wherein the system further comprises:
at least one beacon arrangement which is configured to communicate with the central control arrangement and the client device, wherein the at least one beacon arrangement is configured to communicate with the client device over a limited distance range of up to 500 metres.

4. (canceled)

5. The system of claim 3, wherein the at least one beacon arrangement is configured to communicate directly with the client device over a limited distance range of up to 100 metres.

6. (canceled)

7. The system of claim 3, wherein the client device is configured to restrict the user from accessing at least one function of the client device when the client device is not within the limited distance range of the at least one beacon arrangement.

8. The system of claim 3, wherein the central control arrangement is configured to calculate a geographic position of the client device relative to a known geographic position of the at least one beacon arrangement based on data communication between the client device and the at least one beacon arrangement.

9. The system of claim 1, wherein the client device is configured to:
send the tracking request to the central control arrangement, the tracking request requesting the tracking data corresponding to the one or more of the vessel or the cargo;
receive the portion of the tracking data, the portion of the tracking data corresponding to at least one of:
the vessel data from the plurality of vessel data sources which indicates the at least one vessel status parameter for the vessel, or
the cargo data from the at least one cargo data source which comprises at least the item identifier which identifies the item of cargo carried by the vessel; and
output at least some of the portion of the tracking data to a user interface of the client device.

10.-13. (canceled)

14. The system of claim 1, wherein the plurality of vessel data sources are selected from a group consisting of a port authority system, a marine service provider system, a customs authority system, a port operator system, a shipping line system, a shipping agent system or a system accessible via Internet.

15.-21. (canceled)

22. The system of claim 1, wherein the central control arrangement is configured to:
transmit a port clearance document to the client device to enable the user to process a port clearance document related to the vessel using the client device.

23.-24. (canceled)

25. The system of claim 1, wherein the central control arrangement further comprises:
a machine learning module which is configured to use machine learning to analyse historical data and current data generated by the system to generate at least one of a predicted arrival time or a predicted departure time for the vessel.

26. A tracking method comprising:
receiving vessel data from a plurality of vessel data sources, the vessel data indicating at least one vessel status parameter for a vessel;
receiving cargo data from at least one cargo data source, the cargo data comprising at least an item identifier which identifies an item of cargo carried by the vessel;
receiving port data from at least one port data source, the port data comprising at least one port parameter related to the vessel;
storing the vessel data, the cargo data and the port data in a memory of a central control arrangement of a tracking system;
receiving a tracking request which requests tracking data corresponding to one or more of the vessel or the cargo; and
in response to the tracking request, outputting at least a portion of the tracking data to a user to enable the user to track at least one of the vessel or the cargo.

27. The method of claim 26, wherein the method further comprises:
communicating data between a client device of the user and at least one beacon arrangement directly over a limited distance range of up to 500 metres.

28.-30. (canceled)

31. The method of claim 27, wherein the method further comprises:
restricting the user from accessing at least one function of the client device when the client device is not within the limited distance range of the at least one beacon arrangement.

32. The method of claim 27, wherein the method further comprises:
calculating a geographic position of the client device relative to a known geographic position of the at least one beacon arrangement based on data communication between the client device and the at least one beacon arrangement.

33.-41. (canceled)

42. The method of claim 26, wherein the method further comprises:
providing an alert message to the user comprising at least some of the portion of the tracking data.

43. (canceled)

44. The method of claim 26, wherein the method further comprises:
grouping a portion of the vessel data and a portion of the cargo data for the user to form grouped vessel data and cargo data; and
outputting to the user at least a portion of the tracking data corresponding to the grouped vessel data and cargo data.

45. The method of claim 26, wherein the method further comprises:
transmitting a port clearance document from the central control arrangement to a mobile device to enable the user to process a port clearance document related to the vessel using the mobile device.

46. The method of claim 26, wherein the method further comprises:
storing statistics data corresponding to at least one of the vessel data and/or the cargo data over period of time.

47. The method of claim 26, wherein the method further comprises:
using machine learning to analyse historical data and current data generated by the system to generate at least one of a predicted arrival time or a predicted departure time for the vessel.

48.-50. (canceled)

51. A tangible computer readable medium storing instructions which, when executed by a processor, cause the processor to perform a method comprising:
receiving vessel data from a plurality of vessel data sources, the vessel data indicating at least one vessel status parameter for a vessel;
receiving cargo data from at least one cargo data source, the cargo data comprising at least an item identifier which identifies an item of cargo carried by the vessel;
receiving port data from at least one port data source, the port data comprising at least one port parameter related to the vessel;
storing the vessel data, the cargo data and the port data in a memory of a central control arrangement of a tracking system;
receiving a tracking request which requests tracking data corresponding to one or more of the vessel or the cargo; and
in response to the tracking request, outputting at least a portion of the tracking data to a user to enable the user to track at least one of the vessel or the cargo.
